(19) United States
(12) Patent Application Publication
(10) Pub. No.: US 2007/0054521 A1
(43) Pub. Date: Mar. 8, 2007

(54) Dust-proof cover for network jack

(76) Inventor: Peng John, Taipei (TW)

Correspondence Address: SILICON VALLEY PATENT GROUP LLP, 2350 MISSION COLLEGE BOULEVARD, SUITE 360, SANTA CLARA, CA, 95054, US

(21) Appl. No.: 11/437,914

(22) Filed: May 19, 2006

(30) Foreign Application Priority Data
Aug. 16, 2005 (TW) 094127939

(51) Int. Cl. H01R 13/44

(52) U.S. Cl. 439/136

(57) ABSTRACT

A dust-proof cover for a network jack is provided. The dust-proof cover includes a cover body having a covering surface, a connecting portion disposed on the cover body, and a fixing portion mounted outwardly on the connecting portion and connected to the cover body through the connecting portion to fix the cover body to the network jack so that the covering surface closely seals the opening of the network jack.

### FIELD OF THE INVENTION

The present invention relates to a dust-proof cover for a network jack. More particularly, the present invention relates to a dust-proof cover for a network jack where the dust-proof cover has a covering surface closely sealing an opening of the network jack.

### BACKGROUND OF THE INVENTION

When a network jack of RJ-45 type (registered as Jack-45) is mounted on a panel or a faceplate without a dust-proof cover, an outer surface thereof is exposed to the ambient air. For cleanness reason, it is generally suggested to place a dust-proof cover on the network jack so as to avoid dust from entering the jack through an opening thereof and thus deposited in the jack. However, an electrical connection between the jack and a jump wired plug may be undesirably affected by the dust-proof cover due to its combination with the jack. Referring to FIG. 1, the network jack 10 is protected by a square dust-proof cover 11 to prevent dust from entering the opening 12 of the jack 10. A groove 20 as shown in FIG. 2 is mounted at each side of the square dust-proof cover 11 so that the square dust-proof cover 11 may be connected to two protruding posts 21 of the network jack 10. When the square dust-proof cover 11 is used to close the network jack 10, the two grooves 20 are fitted to the two protruding posts 21. Then, the square dust-proof cover 11 is rotated and seals the outer surface 13 of the network jack 10. Further, an opening portion 15 may be provided on the square dust-proof cover 11 so that the square dust-proof cover 11 may be facilitated to be opened. However, since dimension of the dust-proof cover 11 is larger than that of the opening 12 of the network jack 10, an inner surface 14 of the dust-proof cover 11 is seated against the outer surface 13, and the dust-proof cover 11 is protruded on the outer surface 13 of the network jack 10 when the dust-proof cover 11 mates with the network jack 10.

Referring to FIG. 3, another network jack 30 is shown therein. The protruding posts 21 shown in FIGS. 1 and 2 are herein replaced by two grooves 40 of the network jack 30 shown in FIG. 4. And two rotation shafts 41 are disposed on a bottom side 33 of the dust-proof cover 32 so that they may be rotated within the grooves 40, and thus the dust-proof cover 32 may mate with the outer surface 34 of the network jack 30. However, dimension of the dust-proof cover 32 is also greater than that of the opening 35 of the network jack 30. Like the case shown in FIG. 2, the inner surface 42 of the dust-proof cover 32 is seated against the outer surface 34, and the dust-proof cover 32 protrudes on the outer surface 34 of the network jack 30. Furthermore, the dust-proof cover 32 protrudes on a panel 50, shown in FIG. 5A, or a faceplate 50, shown in FIG. 5B which seems not visually simple. Thus, it is desired to be improved.

Therefore, it is a need to provide a dust-proof cover for a network jack where the problems that the dust-proof cover sits against and protrudes on the network jack and even a connection portion thereof also protrudes on the network jack, may be solved. After a long intensive series of experiments and researches, the inventor finally sets forth such dust-proof cover, which is exempted from the aforementioned problems. dust-proof cover for a network jack, comprising a cover body having a covering surface, a connecting portion disposed on the cover body, and a fixing portion mounted outwardly on the connecting portion and connected to the cover body through the connecting portion to fix the cover body to the network jack so that the covering surface closely seals the opening of the network jack.

Preferably, the network jack comprises a jack body having a double-indentation portion and a receptive portion disposed thereon to receive the connecting portion therein.

Preferably, the receptive portion has an outer opening for receiving the fixing portion therein.

Preferably, the fixing portion is a protrusive cylinder and the outer opening is a circular indentation so that the fixing portion is allowed to rotate in the circular indentation.

Preferably, the circular indentation has a gap so that the protrusive cylinder is facilitated to be pushed into the circular indentation.

Preferably, the cover body has a double-protrusion portion used to mate with the double-indentation portion of the jack body.

Preferably, the cover body, connecting portion and fixing portion are formed integrally.

Preferably, the cover body has an opening portion to facilitate the dust-proof cover to be rotated to an open position from a close position.

According to another aspect of the present invention, a dust-proof cover for a network jack having an opening is provided, comprising a cover body having a covering surface, and a fixing device having a connecting portion mounted outwardly to the cover body, connected to the cover body cover for a network jack having an opening is provided, comprising a cover body having a covering surface, and a fixing device having a connecting portion mounted outwardly to the cover body, connected to the cover body through the connecting portion to fix the cover body on the network jack so that the covering surface closely seals the opening of the network jack.

Preferably, the fixing device comprises the connecting portion and a fixing portion, the connecting portion being mounted on the cover body.

Preferably, the network jack comprises a jack body having a receptive portion disposed thereon to receive the connecting portion therein.

Preferably, the receptive portion has an outer opening for receiving the fixing portion therein.

Preferably, the fixing portion is a protrusive cylinder and the outer opening is a circular indentation so that the fixing portion is allowed to rotate in the circular indentation.

Preferably, the circular indentation has a gap so that the protrusive cylinder is facilitated to be pushed into the circular indentation.

According to yet another aspect of the present invention, a network jack having an opening is provided, comprising a cover body having an exposed surface, and a dust-proof cover, comprising a cover body having a covering surface, and a fixing device mounted outwardly on the cover body and connected to the cover body through a connecting portion to fix the cover body on the network jack so that the covering surface closely seals the opening of the network jack.

Preferably, the fixing device comprises the connecting portion and a fixing portion, the connecting portion being mounted on the cover body.

Preferably, the network jack comprises a jack body having a receptive portion disposed thereon to receive the connecting portion therein.

Preferably, the receptive portion has an outer opening for receiving the fixing portion therein.

Preferably, the fixing portion is a protrusive cylinder and the outer opening is a circular indentation so that the fixing portion is allowed to rotate in the circular indentation.

Preferably, the circular indentation has a gap so that the protrusive cylinder is facilitated to be pushed into the circular indentation.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods disclosed or illustrated. In the drawings:

FIG. 1 is a prospective view schematically showing a dust-proof cover for a network jack in the prior art;

FIG. 2 is a prospective view schematically showing grooves and protruding posts of the dust-proof cover shown in FIG. 1;

FIG. 3 is a front view schematically showing another dust-proof cover for the network jack in the prior art;

FIG. 4 is a prospective view schematically showing grooves and rotation shafts of the dust-proof cover shown in FIG. 3;

FIG. 5A and FIG. 5B are a prospective view schematically showing one form and another form of a panel assembled with the network jack shown in FIG. 3;

FIG. 6 is an exploded view schematically showing a dust-proof cover for the network jack according to the present invention;

FIG. 7 is a diagram schematically showing the dust-proof cover being at a close position with respect to the network jack shown in FIG. 6 according to the present invention; and

FIG. 8 is a diagram schematically showing the dust-proof cover being at an open position with respect to the network jack shown in FIG. 6 according to the present invention.

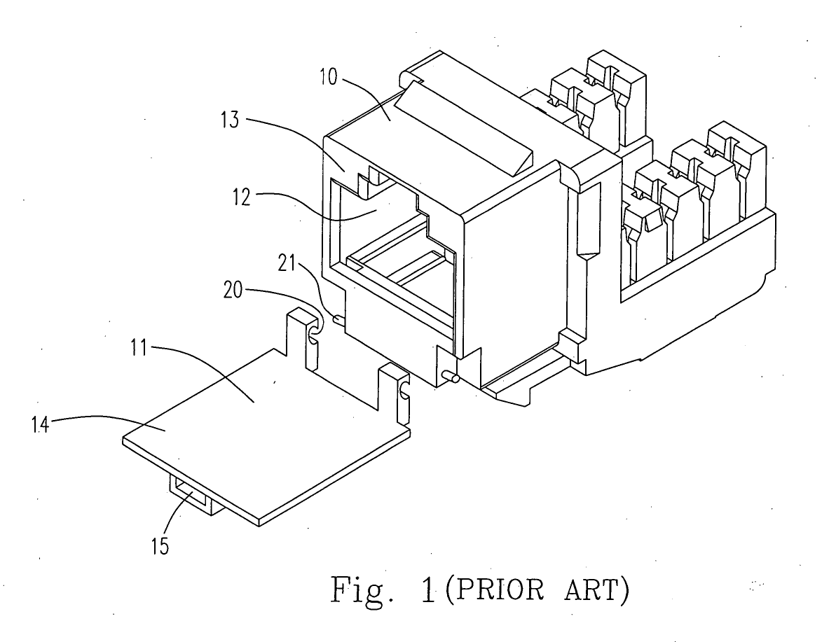

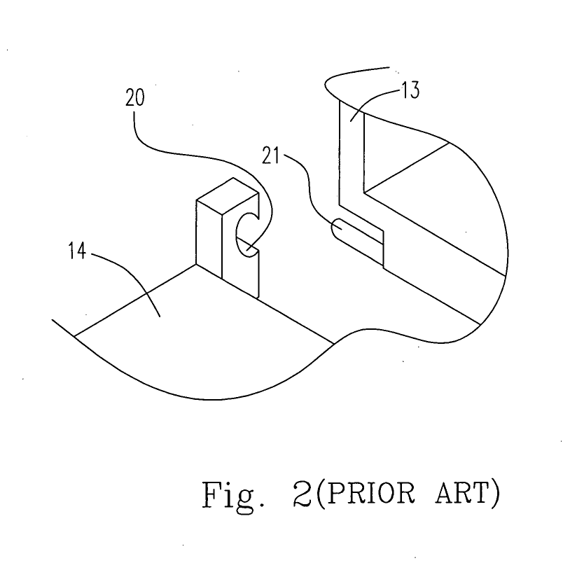

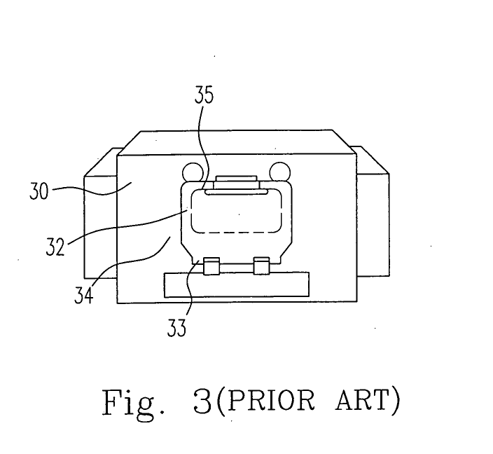

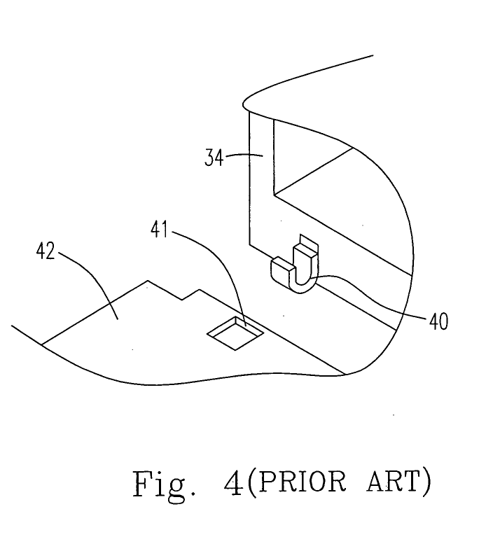

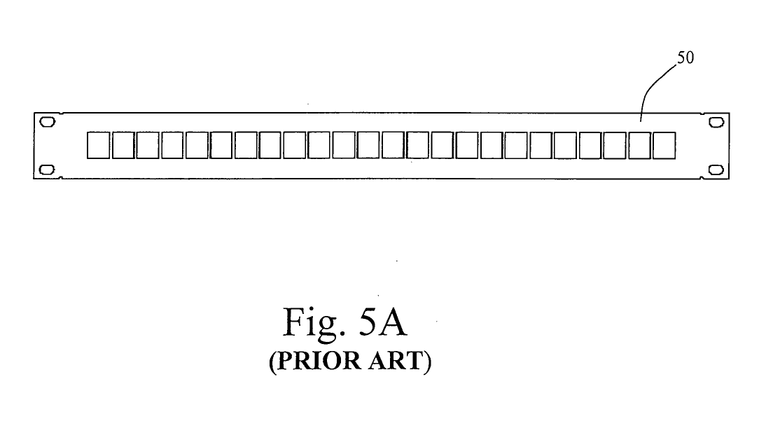

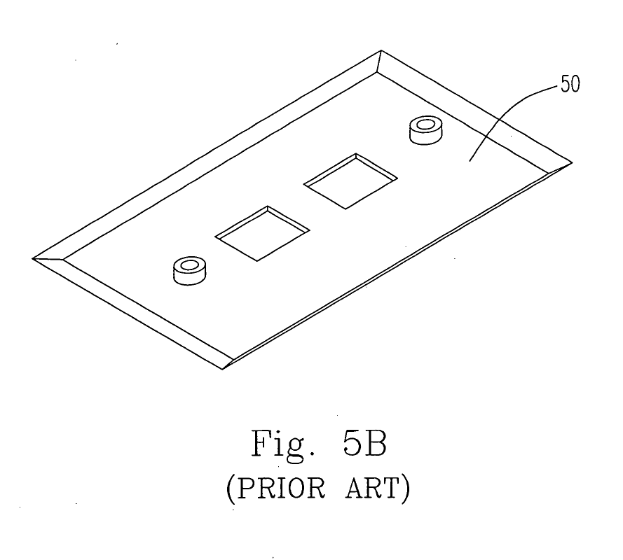

### DETAILED DESCRIPTION OF THE PREFERRED EMBODIMENT

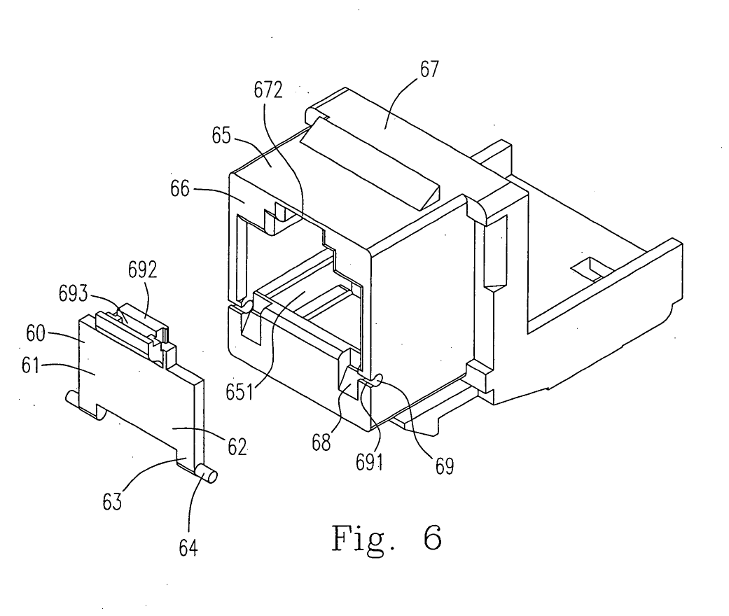

Referring to FIG. 6, a dust-proof cover for a network jack is shown therein. As shown, the dust-proof cover comprises a cover body 61 having a covering surface 62, a connecting portion 63 mounted on the cover body 61 and a fixing portion 64 mounted outwardly on the connecting portion 63 and connected to the cover body 61 through the connecting portion 63 for fixing the cover body 61 on a network jack 65 to be protected by the dust-proof cover 60, so that the covering surface 62 may close an opening of the network jack 65.

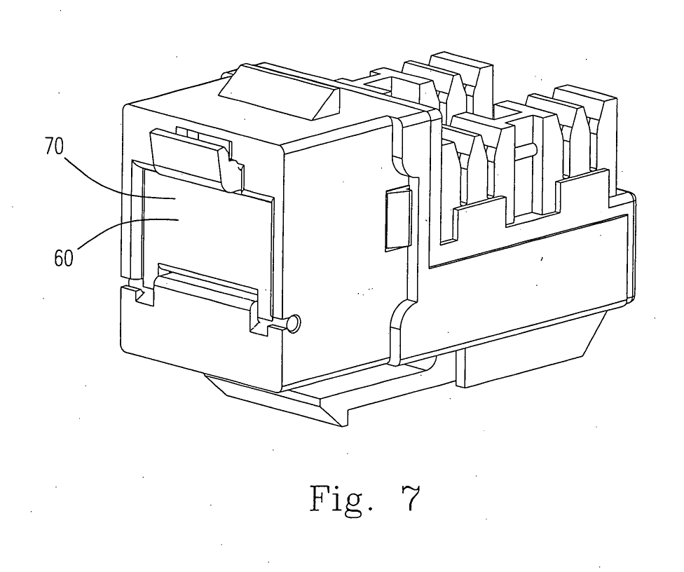

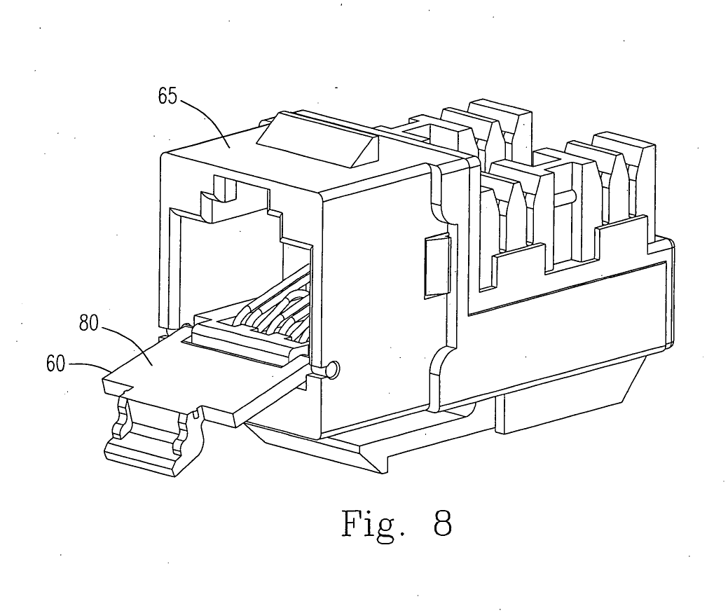

The dust-proof cover 60 for the network jack 65 comprises a jack body 67 having a receptive portion 68 thereon for receiving the connecting portion 63 therein. The receptive portion 68 has an outer opening 69 for receiving the fixing portion 64 therein. The fixing portion 64 may be a protrusive cylinder 64 and the outer opening 69 is a circular indentation 69, so that the protrusive cylinder 64 may be rotated within the circular indentation 69. The circular indentation 69 has a recess 691 so that the protrusive cylinder 64 may be facilitated to be pushed into the indentation 69. The cover body 61 has a double-protrusion portion 692 which is received in a double-indentation portion 672 of the jack body 67. In the configuration, the cover body 61, the connecting portion 63 and the fixing portion 64 are formed integrally. The cover body 61 may have an opening portion 693, through which the dust-proof cover 60 may be facilitated to be rotated from a close position 70 shown in FIG. 7 to an open position 80 shown in FIG. 8. Further, the covering surface 62 of the dust-proof cover 60 is located into an outer surface 66 of the network jack 65. As such, the covering surface 62 of the dust-proof cover 60 looks like an indent.

The dust-proof cover for the network jack according to another aspect of the present invention comprises the cover body 61 having the covering surface 62 and a fixing device (comparable to the connecting portion 63 and fixing portion 64 described above) mounted outwardly on the cover body 61 and connected to the cover body 61 through the connecting portion 63 for fixing the cover body 61 to the network jack 65, so that the covering surface 62 may close the opening 651 of the network jack 65. Certainly, the fixing device of the dust-proof cover 60 may comprise the connecting portion 63 and the fixing portion 64, and the connecting portion 63 is herein mounted on the cover body 61. As to other details of the integral combination of the connecting portion 63 and the fixing portion 64, they may be referred to the above description and will be omitted herein for conciseness.

According to yet another aspect of the present invention, the network jack 65 comprises a jack body 67 having an outer surface 66, a dust-proof cover 60 comprising a cover body 61 having a covering surface 62, and a fixing device as described above mounted on the cover body 61 and connected to the cover body 61 through the connecting portion 63 for fixing the cover body 61 on the jack body 67 so that the covering surface 62 may close the opening 651 of the network jack 651. Certainly, the fixing device of the network jack 65 comprises the connecting portion 63 and the fixing portion 64, wherein the connecting portion 63 is mounted on the cover body 61. As to other details of the dust-proof cover 60, they may be referred to the above description and will be omitted herein for conciseness.

In conclusion, the combination of the network jack and dust-proof cover may actually achieve the purposes where the cover body may be fixed to the network jack, which is achieved by the fixing portion outwardly mounted on the connecting portion. In the present invention, the covering surface of the dust-proof cover may closely seal the opening of the network jack, compared with that in the prior art where the covering surface protrudes on the outer surface of the network jack.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A dust-proof cover for a network jack having an opening, comprising:
a cover body having a covering surface;
a connecting portion disposed on the cover body; and
a fixing portion mounted outwardly on the connecting portion and connected to the cover body through the connecting portion to fix the cover body to the network jack so that the covering surface closely seals the opening of the network jack.

2. The dust-proof cover according to claim 1, wherein the network jack comprises a jack body having a double-indentation portion and a receptive portion disposed thereon to receive the connecting portion therein.

3. The dust-proof cover according to claim 2, wherein the receptive portion has an outer opening for receiving the fixing portion therein.

4. The dust-proof cover according to claim 3, wherein the fixing portion is a protrusive cylinder and the outer opening is a circular indentation so that the fixing portion is allowed to rotate in the circular indentation.

5. The dust-proof cover according to claim 4, wherein the circular indentation has a gap so that the protrusive cylinder is facilitated to be pushed into the circular indentation.

6. The dust-proof cover according to claim 2, wherein the cover body has a double-protrusion portion used to mate with the double-indentation portion of the jack body.

7. The dust-proof cover according to claim 1, wherein the cover body, connecting portion and fixing portion are formed integrally.

8. The dust-proof cover according to claim 1, wherein the cover body has an opening portion to facilitate the dust-proof cover to be rotated to an open position from a close position.

9. A dust-proof cover for a network jack having an opening, comprising:
a cover body having a covering surface; and
a fixing device having a connecting portion mounted outwardly to the cover body, connected to the cover body through the connecting portion to fix the cover body on the network jack so that the covering surface closely seals the opening of the network jack.

10. The dust-proof cover according to claim 9, wherein the fixing device comprises the connecting portion and a fixing portion, the connecting portion being mounted on the cover body.

11. The dust-proof cover according to claim 10, wherein the network jack comprises a jack body having a receptive portion disposed thereon to receive the connecting portion therein.

12. The dust-proof cover according to claim 11, wherein the receptive portion has an outer opening for receiving the fixing portion therein.

13. The dust-proof cover according to claim 12, wherein the fixing portion is a protrusive cylinder and the outer opening is a circular indentation so that the fixing portion is allowed to rotate in the circular indentation.

14. The dust-proof cover according to claim 13, wherein the circular indentation has a gap so that the protrusive cylinder is facilitated to be pushed into the circular indentation.

15. A network jack having an opening, comprising:
a cover body having an exposed surface; and
a dust-proof cover, comprising:
a cover body having a covering surface; and
a fixing device mounted outwardly on the cover body and connected to the cover body through a connecting portion to fix the cover body on the network jack so that the covering surface closely seals the opening of the network jack.

16. The network jack according to claim 15, wherein the fixing device comprises the connecting portion and a fixing portion, the connecting portion being mounted on the cover body.

17. The network jack according to claim 16, wherein the network jack comprises a jack body having a receptive portion disposed thereon to receive the connecting portion therein.

18. The network jack according to claim 17, wherein the receptive portion has an outer opening for receiving the fixing portion therein.

19. The network jack according to claim 18, wherein the fixing portion is a protrusive cylinder and the outer opening is a circular indentation so that the fixing portion is allowed to rotate in the circular indentation.

20. The network jack according to claim 19, wherein the circular indentation has a gap so that the protrusive cylinder is facilitated to be pushed into the circular indentation.
